(19) United States
(12) Patent Application Publication
(10) Pub. No.: US 2006/0169936 A1
(43) Pub. Date: Aug. 3, 2006

(54) Solenoid Valves

(76) Inventors: Takumi Nonaka, Hachimantai-City (JP); Mitsuhiro Iwaana, Hachimantai-City (JP); Hideki Watanabe, Hachimantai-City (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/275,736

(22) Filed: Jan. 26, 2006

(30) Foreign Application Priority Data
Jan. 28, 2005 (JP) 2005020567

(51) Int. Cl. F16K 31/02

(52) U.S. Cl. 251/129.02

(57) ABSTRACT

In a solenoid valve, a desire valve stroke width may be set, and a flow rate may be returned to an original flow rate even when that the flow rate is changed. A solenoid valve includes a drive portion having a bobbin including a slidable hole formed there through, a fixed iron core disposed with in the bobbin and a movable iron core disposed to be slidable within the slidable hole, and a valve function portion having a valve body extending from the movable iron core and disposed in a leading end of a valve shaft passing through the fixed iron core and a valve seat with which the valve body is brought into close contact and from which the valve body is separated. In the solenoid valve, a predetermined gap width is formed between the valve body and the valve seat, when the solenoid valve is not energized, to open the valve, and the movable iron core is drawn to the fixed iron core when the solenoid valve is energized to close the valve. A valve stroke width may be adjusted by screwing a flow rate adjusting screw from an outer side in a rear end of the solenoid valve to bring the leading end into contact with a rear end surface of the movable iron core when the valve is opened, thereby adjusting a protrusion amount of the screw in the leading end of the slidable hole.

### BACKGROUND OF THE INVENTION

1. Field of the Invention

The present invention relates to solenoid valves which control a fluid flow by opening and closing a valve in response to the application of a current.

2. Description of Related Art

A normally closed-type, solenoid valve (e.g., an electromagnetic valve), which is opened in response to the attraction of a movable iron core (e.g., an armature) to a fixed iron core (e.g., a core) magnetized by the application of a current to a surrounding coil, is frequently used as a valve for controlling the opening and the closing of a fuel supply, pipe line and a working fluid, supply path of a vehicle. On the other hand, a normally open-type, solenoid valve which is normally opened and is closed when electricity is applied, also is known, for example, as described in Japanese Unexamined Patent Publication No. H09-229229. The normally open-type, solenoid valve has an advantage that a flow rate may be maintained and that an engine may be operated continuously even when a current supply for driving is intermittent or interrupted.

In the solenoid valve used for controlling the fluid flows as described above, a magnitude (e.g., a width) of a valve stroke generally is limited, a width of a gap formed between a valve body and a valve seat and constituting a flow path may become excessive due to a slight variation part dimensions and a slight inaccuracies at the time of assembling, or a change in width may occur due to a long-term use, whereby an initially expected flow rate may not be obtained or maintained.

With respect to these problems, Japanese Unexamined Patent Publication No. H05-18473 describes a configuration, such that a temporary spacer is interposed between a fixed iron core and a movable iron core when the solenoid is assembled, and a desired air gap is formed between the fixed iron core and the movable iron core when solenoid assembly is completed. Further, Japanese Unexamined Patent Publication No. H07-27246 describes a configuration, such that various dimensions constituting a valve stroke width are measured when assembling a normally open-type, solenoid valve, and a desired valve stroke width is set by selecting a shaft receiving plate having a width corresponding thereto.

On the basis of these configurations, even if the precision with which parts are manufactured and assembled is not high, a desired valve stroke width may be achieved, and an accurate flow rate may be obtained, when the valve is opened. Nevertheless, in the configuration described in Japanese Unexamined Patent Publication No. H05-18473, the temporary spacer must be attached and detached when assembling the valve, and the number of assembly steps is increased, resulting in a cost increase. On the other hand, in the configuration described in Japanese Unexamined Patent Publication No. H07-27246, a plurality of dimensions must be accurately measured before assembling the valve, and manufacturing time is increased significantly.

Further, among both of these configurations, when the width of the gap formed by the valve seat and the valve body is changed through use of the solenoid valve over a long term, and the flow rate is changed to a different flow rate from the original or initial flow rate when the valve was opened, it is difficult to adjust to this situation.

### SUMMARY OF THE INVENTION

The present invention solves the problems described above, and a technical advantage of the present invention is to provide a solenoid valve in which a valve stroke width may be set readily to obtain a desired flow rate, and the flow rate may return to an initial or original flow rate by making it possible to adjust the flow rate even when the original flow rate may not be obtained or maintained due to wear.

In order to solve the problems described above, a solenoid valve is provided comprising:

a drive portion comprising a bobbin comprising a slidable hole formed therethrough, a fixed iron core disposed in the slidable hole and a movable iron core slidably disposed within the slidable hole; and

a valve function portion comprising a valve body extending from the movable iron core and disposed in a leading end of a valve shaft passing through the fixed iron core and a valve seat with which the valve body is brought into close contact and from which the valve body is separated,

wherein a magnitude of a gap formed between the valve body and the valve seat is adjustable when the valve is opened, by means of a flow rate adjusting screw, which may be adjusted from an outer side in a rear end of the solenoid valve and comprises a leading end protruding into the slidable hole to bring the leading end into contact with a rear end surface of the movable iron core when the valve is opened, thereby adjusting a protrusion amount of the screw into the leading end of the slidable hole.

Accordingly, a valve stroke width may be adjusted precisely without requiring a precise dimensional accuracy in valve components and a precise accuracy in assembling the valve, and even when a width of an original gap formed between the valve body and the valve seat may become excessive due to use and may generate a flow rate, it is possible to return to the initial gap width only by turning the flow rate adjusting screw.

On the other hand, a solenoid valve may be provide, comprising:

a valve function portion comprising a bobbin, a fixed iron core disposed to be brought into close contact with the bobbin or integrally formed with the bobbin and a movable iron core to be slidable along an axial direction in an exciting end surface side of the fixed iron core; and

a valve function portion comprising a valve shaft extended from the movable iron core toward a leading end, a valve body disposed in a leading end of the valve shaft and a valve seat with which the valve body is brought into close contact and from which the valve body is separated,

wherein a magnitude of a gap formed between the valve body and the valve seat is adjustable when the valve is opened, by means of a flow rate adjusting screw adjustable from an outer side in a rear end of the solenoid valve and protruding to an inner portion of the valve to bring the leading end into contact with a rear end surface of the movable iron core when the valve is opened, thereby adjusting a protrusion amount of the screw into the leading end of the slidable hole. Accordingly, a solenoid valve of a face-type, in which the movable iron core is formed in a disc shape and is not accommodated in an inner peripheral side of the bobbin, also may be utilized.

Further, when the solenoid valve structured is configured as a normally open-type, solenoid valve, which is opened by forming a gap between the valve body and the valve seat when the solenoid valve is not energized, and is closed when the movable iron core is drawn to the fixed iron core when the solenoid valve is energized, a valve open state may be maintained even when the current applied to drive the solenoid valve is intermittent or interrupted. Alternatively, when the solenoid valve is configured as a normally closed-type, solenoid valve which is closed when the solenoid valve is not energized, and is opened by creating a gap between the valve body and the valve seat when the movable iron core is drawn to the fixed iron core when the solenoid valve is energized, the fluid within the pipe may be sealed, such that when the valve is closed, the fluid is not delivered.

Further, when the flow rate adjusting screw is formed of a non-magnetic material, the flow rate adjusting screw is not excited by applying the current to the drive portion. Thus, valve operation is not affected by a movement of the movable iron core.

Further, when a seal means for making an inner portion airtight and liquid-tight with respect to an outer portion is provided in a through hole formed in an outer side in a rear end of the solenoid to which the flow rate adjusting screw is inserted, air and liquid may be prevented from intruding from the outer portion so as to well maintain the valve function and the nature of the fluid without requiring tight tolerances between the flow rate adjusting screw and the through hole. When the seal means comprises an O-ring disposed with respect to the flow rate adjusting screw within the through hole to which the flow rate adjusting screw is inserted, a sealing function may be achieved without increasing costs.

In accordance with the present invention having the uncomplicated structure as described above, a valve stroke width may be achieved to maintain a desired flow rate when assembling the solenoid valve easily and at a low cost. Further, even when the width of the gap formed between the valve body and the valve seat is changed due to the use, and the original flow rate may remain unobtainable, the original flow rate may be achieved on the basis of a straightforward operation of only turning the flow rate adjusting screw so as to adjust flow.

Further objects, features, and advantages of the present invention will be understood from the following detailed description of preferred embodiments of the present invention with reference to the accompanying figures.

### BRIEF DESCRIPTION OF THE DRAWINGS

Embodiments of the invention now are described with reference to the accompanying figures, which are given by way of example only, and are not intended to limit the present invention.

FIG. 1 is a cross-sectional view showing a first embodiment in accordance with the present invention.

FIG. 2A is a cross-sectional view showing a valve opened state for explaining operation of a solenoid valve in FIG. 1.

FIG. 2B is a cross-sectional view showing a valve closed state for explaining operation of the solenoid valve in FIG. 1.

FIG. 3A is a cross-sectional view showing the valve opened state for adjusting a flow rate of the solenoid valve in FIG. 1.

FIG. 3B is a cross-sectional view showing the valve opened state for adjusting the flow rate of the solenoid valve in FIG. 1.

FIG. 4 is a cross-sectional view showing a second embodiment in accordance with the present invention.

FIG. 5 is a cross-sectional view showing another example of the solenoid valve in FIG. 1.

FIG. 6 is a cross-sectional view showing another example of the solenoid valve in FIG. 4.

### DESCRIPTION OF PREFERRED EMBODIMENTS

A description is given below of embodiments in accordance with the present invention and with reference to the accompanying drawings. In the present invention, as a matter of convenience, the member magnetized by energizing an electric conduction coil of a bobbin may be referred to as a fixed iron core, and the member sliding in an axial direction in an inner portion of a solenoid valve and drawn by a magnetic force of the fixed iron core may be referred to as a movable iron core. Nevertheless, the members are not limited to iron as long as they are formed of a magnetic material. Further, in the following description, the left side in the drawing is a leading end side, and the right side is a rear end side.

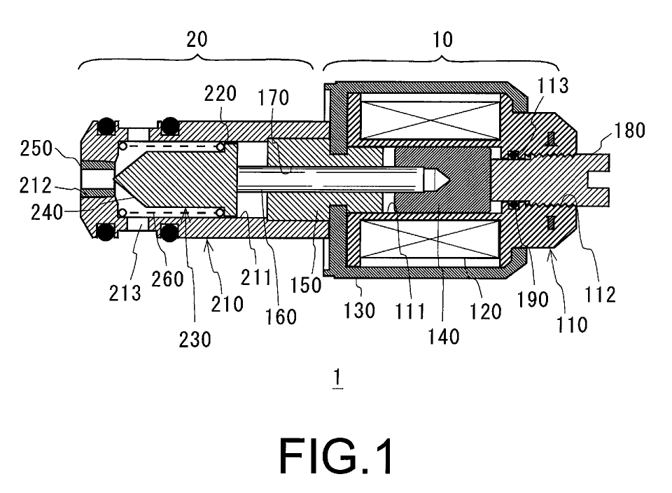

FIGS. 1 to 3 show cross-sectional views of a normally open-type, solenoid valve 1 corresponding to a first embodiment in the present invention. Normally open-type, solenoid valve 1 may be disposed in a fuel supply, pipe path of an engine and may be used as a fluid control valve for a supplied fuel. A right side portion in FIG. 1 depicts a drive portion 10, and a left side portion depicts a valve function portion 20.

Drive portion 10 comprises a slidable hole 111 formed through the center, and comprises an electric conduction coil 120 formed by winding an electric conduction line or wire around an outer periphery of a bobbin 110 corresponding to a main body portion of solenoid valve 1. Electric conduction coil 120 is configured to excite in response to a current, such as a battery current, applied via wiring (not shown). Further, an outer side of bobbin 110 is provided with a cover body 130 covering bobbin 110 and sealing an inner portion of bobbin 110. An substantially columnar, movable iron core 140 is inserted slidably into slidable hole 111 and extends along a center axis. Further, an substantially cylindrical, fixed iron core 150 is fixed within leading, side opening portion of slidable hole 111, such that about one half of core 150 is fitted and inserted towards a rear end.

A valve shaft 160 is disposed to protrude toward a leading end from a leading end surface of movable iron core 140 and is inserted into a through hole 170 formed through fixed iron core 150. Through hole 170 is formed as a guide hole for sliding valve shaft 160 along a center axis of fixed iron core 150 and slidable hole 111. Further, a flow rate adjusting screw 180 made of a resin or similar non-magnetic material is inserted into a rear end of slidable hole 111 from a rear end, outer side surface of bobbin 110 via a threaded hole 112 and passes there through in to slidable hole 111 to protrude toward the leading end. Further, an O-ring 190 is fitted between a ring groove 113 formed in an inner peripheral flat portion of threaded hole 112 and an outer peripheral flat portion of flow rate adjusting screw 180. Thus, an inner portion of slidable hole 111 is in airtight and liquid-tight separation from an outer portion.

Valve function portion 20 comprises a tube body 210 in which a slidable hole 211 is formed in an inner portion along a center axis, an outlet hole 212 is formed to pass between an inner side and an end surface of a leading end, and an inlet hole 213 is formed to pass between an inner side and an outer periphery of a leading end. A substantially columnar needle 230 is fixed to the leading end side of valve shaft 160 and is formed with a conical shaped tip in a leading end. Substantially columnar needle 230 is disposed slidably within slidable hole 211 and provided with a flange 220 in a rear end. Further, the leading end, conical portion of needle 230 is formed as a valve body 240 and creates an opening and closing mechanism together with an inner opening end of a tubular valve seat 250. Valve body 240 is inserted into outlet hole 212, and is urged in a valve opening direction by a spring 260.

Solenoid valve 1 is structured as described above, and is formed as a less complicated structure which does not result in a cost increase for manufacture in comparison with known, general solenoid valves.

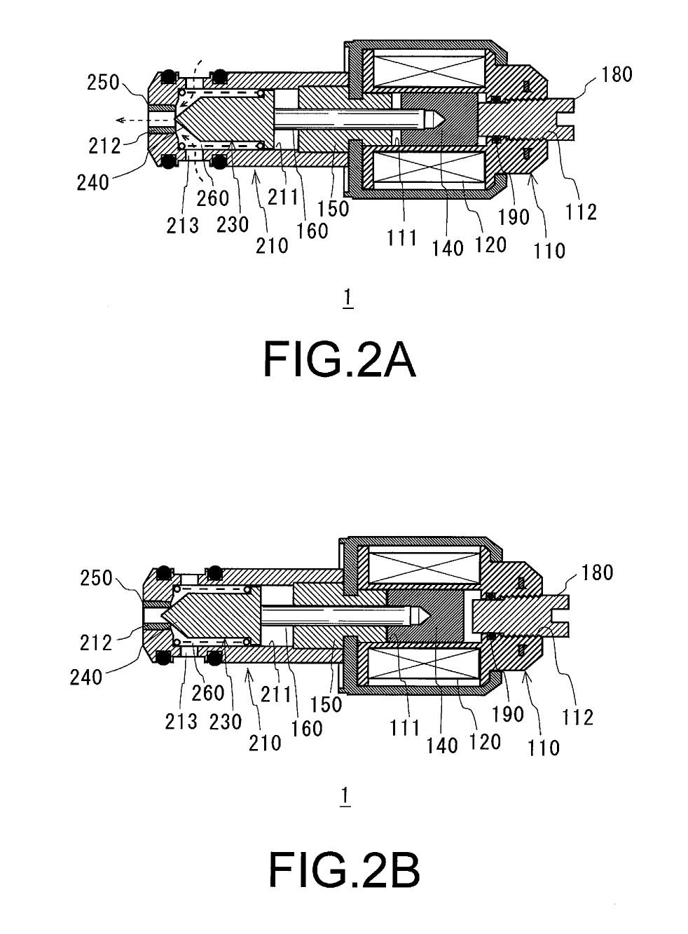

A description now is given of operation of solenoid valve 1 with reference to FIGS. 2A and 2B. Solenoid valve 1 is structured, such that a flow rate, when the valve is opened, may be adjusted by a protrusion amount of flow rate adjusting screw 180 into slidable hole 111. In other words, needle 230 is urged rearward by spring 260 when solenoid valve 1 is not energized. Thus, solenoid valve 1 is opened. Movable iron core 140 also is driven to the rear end side of slidable hole 111. Nevertheless, a gap formed between valve body 240 and valve seat 250, when the valve is opened, is determined by the position at which the leading end surface of flow rate adjusting screw 180 is brought into contact with the rear end surface of movable iron core 140.

Accordingly, because a stroke width may be adjusted appropriately to a desired flow rate without requiring a high degree of dimensional accuracy in the components and without requiring a high degree of accuracy in assembling the components of solenoid valve 1, and because a temporary spacer need not be attached and detached and a plurality of positions need not be accurately measured, increases in the time and cost for manufacturing may be avoided or reduced.

Needle valve 230 is urged rearward by spring 260 in valve function portion 20 as described above when the drive portion 10 is not energized, whereby valve body 240 is separated from valve seat 250 at a predetermined width set by flow rate adjusting screw 180. Thus, a gap may be formed (FIG. 2A), and fuel flowing from inlet hole 213 may be delivered from outlet hole 212 through the gap at a set flow rate.

Further, fixed iron core 150 is magnetized by energizing drive portion 10, and movable iron core 140 is drawn to fixed iron core 150. Accordingly, needle 230 moves forward against a restraining force of spring 260, and valve body 240 is brought into close contact with valve seat 250 to close the valve (FIG. 2B). At this time because flow rate adjusting screw 180 is formed by a resin or a similar non-magnetic material, flow rate adjusting screw 180 is not affected by electric conduction coil 120. Accordingly, the valve operation is not disturbed.

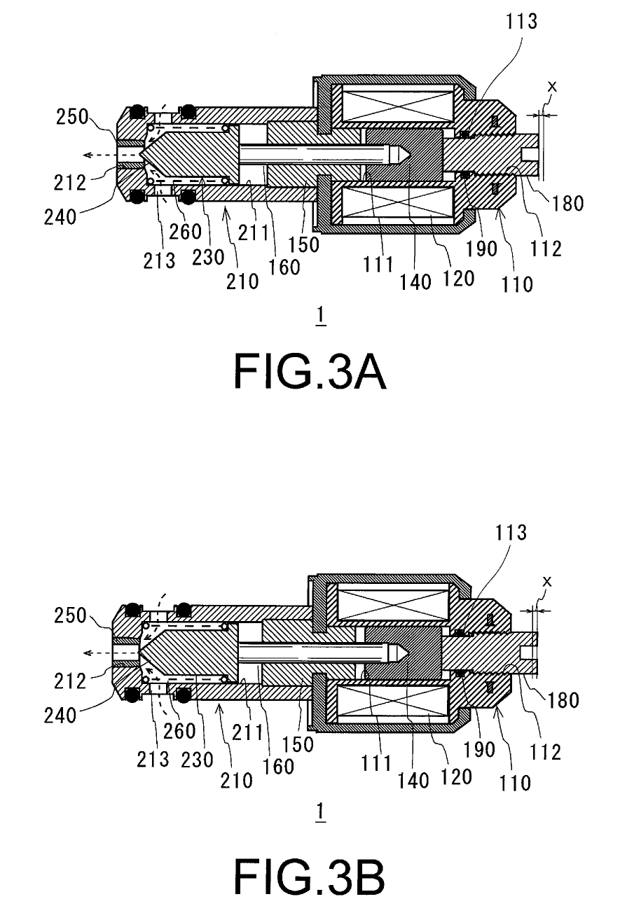

A description now is given of a situation in which the flow rate adjustment of solenoid valve 1 is executed, with reference to FIGS. 3A and 3B. For example, when the originally or initially set gap formed between valve body 240 and valve seat 250 in solenoid valve 1 is reduced due to a long-term use, and the desired flow rate is no longer obtained or maintained (FIG. 3A), the flow rate is adjusted by turning flow rate adjusting screw 180 so as to move screw 180 rearward.

The gap formed between valve body 240 and valve seat 250 is widened to a width X by moving the flow rate adjusting screw 180 rearward by the distance X (FIG. 3B), Consequently, the flow rate is increased, and the originally set flow rate may be obtained. In this case, because circular, ring-shaped ring groove 113 is formed in the flat portion of the inner peripheral surface of threaded hole 112 in the rear end side of bobbin 110, and because O-ring 190 is disposed in groove 113 so as to be brought into close contact with the flat portion of the outer peripheral surface of flow rate adjusting screw 180, a secure seal may be created between threaded hole 112 and flow rate adjusting screw 180. Accordingly, an airtight and liquid-tight seal may be maintained between the inner portion of slidable hole 111 and the outer portion of bobbin 110, and water and air may be excluded from valve 1 to maintain valve function and to preserve fluid nature.

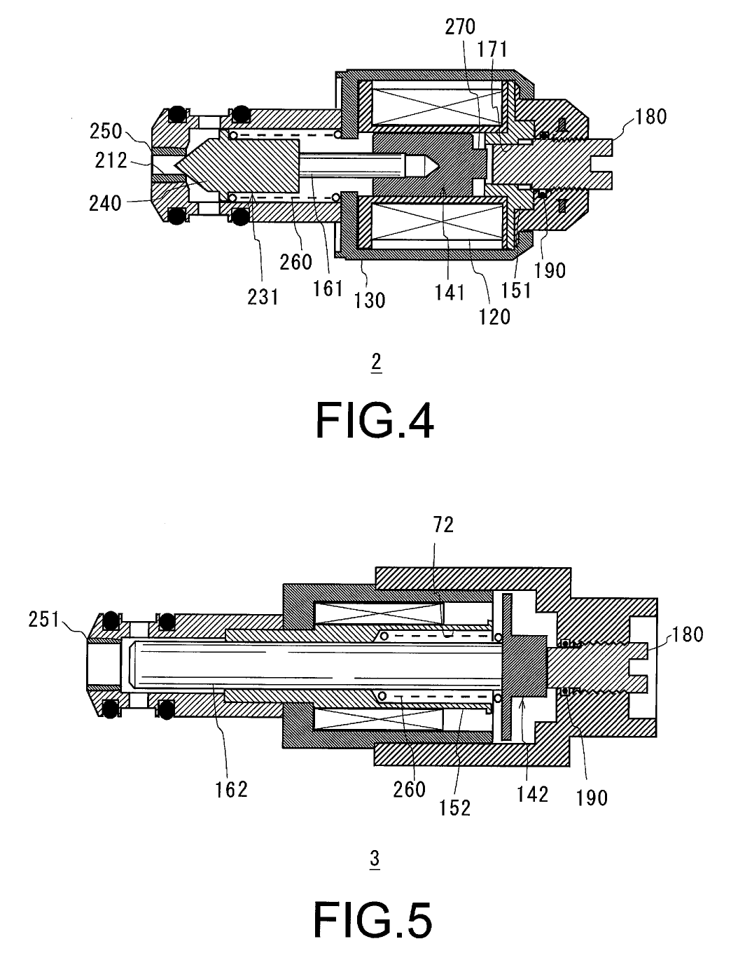

FIG. 4 shows a cross-sectional view of a solenoid valve 2 obtained by applying the present invention to a normally closed-type solenoid valve, in accordance with a second embodiment of the present invention. A difference between solenoid valve 1 and solenoid valve 2 is that in solenoid valve 2, a needle 231 is urged in a valve closing or leading direction by spring 260 to close solenoid valve 2 when solenoid valve 2 is not energized. A movable iron core 141 is drawn by a magnetic force of a fixed iron core 151 disposed in a rear end side, when solenoid valve 2 is energized, so as to be urged rearward and to open the valve. Further, when a leading end surface of flow rate adjusting screw 180 approaches an open end of a through hole 171 as it moves through hole 171 of fixed iron core 151, and screw 180 is brought into contact with the end surface of convex portion 270 protruding to a rear end side of movable iron core 151 when solenoid valve 2 is opened, the size or width of the gap formed between valve body 240 and valve seat 250 may be adjusted from outside valve 2 by flow rate adjusting screw 180. Operations and effects obtained by other structures common to solenoid valves 1 and 2 are substantially the same as those described with respect to solenoid valve 1. In this case, the leading end of needle 231 in accordance with the present embodiment may be manufactured from seal materials, such as metal, rubber, and the like.

With respect to the difference in the operation surface between the normally open-type, solenoid valve and the normally closed-type, solenoid valve, the normally open-type, solenoid valve is advantageous in that the valve open state may be maintained even when the current application for driving the solenoid valve is intermittent or interrupted, and the normally closed-type, solenoid valve is advantageous in that the fluid may be sealed within the pipe during periods in which the fluid is not delivered.

FIG. 5 shows a solenoid valve 3 corresponding to an application example of the normally open-type, solenoid valve 1 shown in FIG. 1. In solenoid valve 1, columnar movable iron core 140 is of a plunger type sliding in a reciprocating manner within slidable hole 111 formed through bobbin 110. On the contrary, solenoid valve 3 is a face-type valve, in which a disc-like movable iron core 142 is urged by spring 260 to separate from a cylindrical fixed iron core 152 and in which spring 260 is disposed in an end portion side of cylindrical, fixed iron core 152. Core 152 comprises a through hole 172 formed there through in an axial direction, which acts as a bobbin, and the movable iron core 142 opposes fixed iron core 152 and is accommodated within the main body. In accordance with the structure described above, the size of the solenoid valve may readily be reduced. Further, in solenoid valve 3, a leading end of a valve shaft 162 acts as a needle having a valve body. Therefore, the number of valve parts may be reduced.

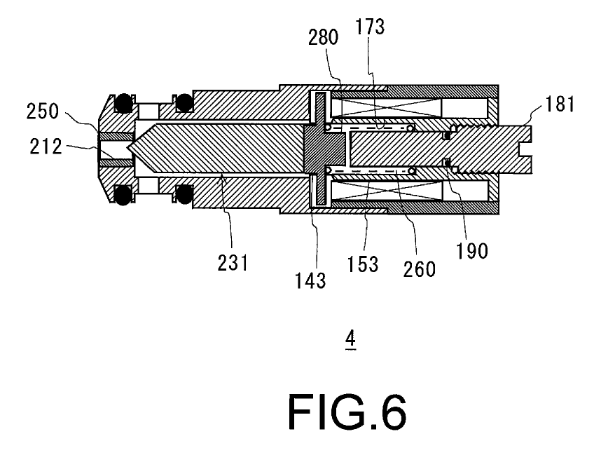

FIG. 6 shows a solenoid valve 4 corresponding to another example of normally closed-type, solenoid valve 2 shown in FIG. 4. A movable iron core 143 is structured as a face-type valve in the same manner as solenoid valve 3 in FIG. 5. Nevertheless, solenoid valve 4 comprises a flow rate adjusting screw 181 made of a non-magnetic material is longer than flow rate adjusting screw 180 described above with respect to FIG. 5. A leading end side of screw 181 is inserted more deeply into an inner portion of a tubular fixed iron core 153. Core 153 acts as a bobbin, and a leading end surface of screw 181 approaches an open end of a through hole 172 of fixed iron core 152, and a leading end surface of flow rate adjusting screw 181 is brought into contact with an end surface of a convex portion 280 which protrudes to rearward from movable iron core 143 and is disposed in the leading end side of tubular fixed iron core 153. In accordance with the structure described above, the size of the solenoid valve may be reduced in the same manner as solenoid valve 3 in FIG. 5. Further, in solenoid valve 4, needle 231 is extended directly from movable iron core 143 while acting as the valve shaft. Therefore, the number of valve parts may be reduced.

In the embodiments described above, each of the solenoid valves is primarily in terms of the structures used as the cutoff mechanisms in the fuel supply pipe of the engine. Nevertheless, the structures are not limited to this function. For example, the solenoid valve may be used as the opening and closing mechanism of the supply pipe line for the working fluid, and the operations and effects described above may be expected in the same manner. Further, the flow rate adjusting screw is not limited to manufacture from resin, but may be made of a non-metallic metal, such as an aluminum, or another non-magnetic material.

Although embodiments of the present invention have been described in detail herein, the scope of the invention is not limited thereto. It will be appreciated by those skilled in the art that various modifications may be made without departing from the scope of the invention. Accordingly, the embodiments disclosed herein are only exemplary. It is to be understood that the scope of the invention is not to be limited thereby, but is to be determined by the claims which follow.

What is claimed is:

1. A solenoid valve comprising:
a drive portion comprising a bobbin comprising a slidable hole formed there through, a fixed iron core disposed in said slidable hole and a movable iron core slidably disposed within said slidable hole; and
a valve function portion comprising a valve body extended from said movable iron core and disposed in a leading end of a valve shaft passing through said fixed iron core and a valve seat with which said valve body is brought into close contact with and from which the valve body is separated,
wherein a magnitude of a gap formed between said valve body and said valve seat is adjustable when the valve is opened, by means of a flow rate adjusting screw adjusted from an outer side in a rear end of said solenoid valve and comprising a leading end protruding into said slidable hole to bring said leading end into contact with a rear end surface of said movable iron core when said valve is opened, thereby adjusting a protrusion amount in said leading end.

2. A solenoid valve comprising:
a drive portion comprising a bobbin, a fixed iron core in close contact with said bobbin or integrally formed with said bobbin and a movable iron core slidable along an axial direction in an exciting end surface of said fixed iron core; and
a valve function portion comprising a valve shaft extended from the movable iron core toward a leading end, a valve body disposed in a leading end of said valve shaft and a valve seat with which said valve body is brought into close contact and from which the valve body is separated,
wherein a magnitude of a gap formed between said valve body and said valve seat is adjustable when the valve is opened, by disposing a flow rate adjusting screw adjustable from an outer side in a rear end of said solenoid valve and protruding a leading end to an inner portion and bringing said leading end into contact with a rear end surface of said movable iron core when said valve is opened, thereby adjusting a protrusion amount in said leading end.

3. The solenoid valve of claim 1, wherein the solenoid valve is a normally open-type solenoid valve which is opened by forming said gap between said valve body and said valve seat when the solenoid valve is not energized, and is closed when said movable iron core drawn to said fixed iron core when the solenoid valve is energized.

4. The solenoid valve of claim 1, wherein the solenoid valve is a normally closed-type solenoid valve which is closed when the solenoid valve is not energized, and is opened by forming said gap between said valve body and said valve seat when said movable iron core is drawn to said fixed iron core when the solenoid valve is energized.

5. The solenoid valve of claim 1, wherein said flow rate adjusting screw is formed of a non-magnetic material.

6. The solenoid valve of claim 3, wherein said flow rate adjusting screw is formed of a non-magnetic material.

7. The solenoid valve of claim 4, wherein said flow rate adjusting screw is formed of a non-magnetic material.

8. The solenoid valve of claim 1, wherein a seal means for making an inner portion airtight and liquid-tight from an outer portion is provided in a through hole to which said flow rate adjusting screw is inserted.

9. The solenoid valve of claim 3, wherein a seal means for making an inner portion airtight and liquid-tight from an outer portion is provided in a through hole to which said flow rate adjusting screw is inserted.

10. The solenoid valve of claim 4, wherein a seal means for making an inner portion airtight and liquid-tight from an outer portion is provided in a through hole to which said flow rate adjusting screw is inserted.

11. The solenoid valve of claim 5, wherein a seal means for making an inner portion airtight and liquid-tight from an outer portion is provided in a through hole to which said flow rate adjusting screw is inserted.

12. The solenoid valve of claim 6, wherein a seal means for making an inner portion airtight and liquid-tight from an outer portion is provided in a through hole to which said flow rate adjusting screw is inserted.

13. The solenoid valve of claim 7, wherein a seal means for making an inner portion airtight and liquid-tight from an outer portion is provided in a through hole to which said flow rate adjusting screw is inserted.

14. The solenoid valve of claim 8, wherein said seal means comprises an O-ring arranged with respect to said flow rate adjusting screw within the through hole to which said flow rate adjusting screw is inserted.

15. The solenoid valve of claim 9, wherein said seal means comprises an O-ring disposed with respect to said flow rate adjusting screw within the through hole to which said flow rate adjusting screw is inserted.

16. The solenoid valve of claim 10, wherein said seal means comprises an O-ring disposed with respect to said flow rate adjusting screw within the through hole to which said flow rate adjusting screw is inserted.

17. The solenoid valve of claim 11, wherein said seal means comprises an O-ring disposed with respect to said flow rate adjusting screw within the through hole to which said flow rate adjusting screw is inserted.

18. The solenoid valve of claim 12, wherein said seal means comprises an O-ring disposed with respect to said flow rate adjusting screw within the through hole to which said flow rate adjusting screw is inserted.

19. The solenoid valve of claim 13, wherein said seal means comprises an O-ring disposed with respect to said flow rate adjusting screw within the through hole to which said flow rate adjusting screw is inserted.

20. The solenoid valve of claim 2, wherein the solenoid valve is a normally open-type solenoid valve which is opened by forming said gap between said valve body and said valve seat when the solenoid valve is not energized, and is closed when said movable iron core drawn to said fixed iron core when the solenoid valve is energized.

21. The solenoid valve of claim 2, wherein the solenoid valve is a normally closed-type solenoid valve which is closed when the solenoid valve is not energized, and is opened by forming said gap between said valve body and said valve seat when said movable iron core is drawn to said fixed iron core when the solenoid valve is energized.

22. The solenoid valve of claim 2, wherein said flow rate adjusting screw is formed of a non-magnetic material.

23. The solenoid valve of claim 20, wherein said flow rate adjusting screw is formed of a non-magnetic material.

24. The solenoid valve of claim 21, wherein said flow rate adjusting screw is formed of a non-magnetic material.

25. The solenoid valve of claim 2, wherein a seal means for making an inner portion airtight and liquid-tight from an outer portion is provided in a through hole to which said flow rate adjusting screw is inserted.

26. The solenoid valve of claim 20, wherein a seal means for making an inner portion airtight and liquid-tight from an outer portion is provided in a through hole to which said flow rate adjusting screw is inserted.

27. The solenoid valve of claim 21, wherein a seal means for making an inner portion airtight and liquid-tight from an outer portion is provided in a through hole to which said flow rate adjusting screw is inserted.

28. The solenoid valve of claim 22, wherein a seal means for making an inner portion airtight and liquid-tight from an outer portion is provided in a through hole to which said flow rate adjusting screw is inserted.

29. The solenoid valve of claim 23, wherein a seal means for making an inner portion airtight and liquid-tight from an outer portion is provided in a through hole to which said flow rate adjusting screw is inserted.

30. The solenoid valve of claim 24, wherein a seal means for making an inner portion airtight and liquid-tight from an outer portion is provided in a through hole to which said flow rate adjusting screw is inserted.

31. The solenoid valve of claim 25, wherein said seal means comprises an O-ring arranged with respect to said flow rate adjusting screw within the through hole to which said flow rate adjusting screw is inserted.

32. The solenoid valve of claim 26, wherein said seal means comprises an O-ring disposed with respect to said flow rate adjusting screw within the through hole to which said flow rate adjusting screw is inserted.

33. The solenoid valve of claim 27, wherein said seal means comprises an O-ring disposed with respect to said flow rate adjusting screw within the through hole to which said flow rate adjusting screw is inserted.

34. The solenoid valve of claim 28, wherein said seal means comprises an O-ring disposed with respect to said flow rate adjusting screw within the through hole to which said flow rate adjusting screw is inserted.

35. The solenoid valve of claim 29, wherein said seal means comprises an O-ring disposed with respect to said flow rate adjusting screw within the through hole to which said flow rate adjusting screw is inserted.

36. The solenoid valve of claim 30, wherein said seal means comprises an O-ring disposed with respect to said flow rate adjusting screw within the through hole to which said flow rate adjusting screw is inserted.
